(19) United States
(12) Patent Application Publication
(10) Pub. No.: US 2017/0134610 A1
(43) Pub. Date: May 11, 2017

(54) Systems and Methods for Universal Imaging Components

(71) Applicant: Static Control Components, Inc., Sanford, NC (US)

(72) Inventors: Richard J. Stievenart, Sanford, NC (US); Michael Larkin Shelby, Cary, NC (US)

(21) Appl. No.: 15/294,840

(22) Filed: Oct. 17, 2016

Related U.S. Application Data
(60) Provisional application No. 62/253,256, filed on Nov. 10, 2015.

(51) Int. Cl. H04N 1/333; G06F 21/74; H04N 1/327; H04N 1/00; H04N 1/44

(52) U.S. Cl. CPC H04N 1/333; H04N 1/00538; H04N 1/0083; H04N 1/4433; H04N 1/32771; G06F 21/74; H04N 2201/0094; H04N 2201/33314; H04N 2201/3205; G06F 2221/2105

(57) ABSTRACT

A method of operating a cartridge chip installed in an imaging device including transmitting a first value to the imaging device in response to a first request from the imaging device; if the first value is accepted by the imaging device, (a) receiving an authentication command from the imaging device and (b) operating in a first mode of operation; if the value is not accepted by the imaging device, waiting for the imaging device to transmit a second request; transmitting a second value to the imaging device in response to a second request from the imaging device, the second value not equaling the first value; if the second value is accepted by the imaging device, (a) receiving an authentication command from the imaging device and (b) operating in a second mode of operation.

The present application claims the benefit of U.S. Provisional Application Ser. No. 62/253,256 filed Nov. 10, 2015 which is incorporated by reference herein in its entirety.

### BACKGROUND

The present invention generally relates to manufacturing or remanufacturing replaceable imaging components, and more particularly to techniques for providing a universal cartridge chip including a memory element adapted for use in multiple types of imaging cartridges.

In the imaging industry, there is a growing market for the remanufacture and refurbishing of various types of replaceable imaging cartridges such as toner cartridges, drum cartridges, inkjet cartridges, and the like. Imaging cartridges, once spent, are unusable for their originally intended purpose. Without a refurbishing process, they would simply be discarded, even though the cartridge itself may still have potential life. As a result, techniques have been developed specifically to address this issue. These processes may entail, for example, the disassembly of the various structures of the cartridge, replacing toner or ink, cleaning, adjusting or replacing any worn components and reassembling the cartridge.

Some imaging cartridges may include a cartridge chip having a memory device which is used to store data related to the cartridge or the imaging device. An imaging device may include laser printers, copiers, inkjet printers, facsimile machines and the like, for example. The imaging device, such as the printer, reads the data stored in the cartridge memory device to determine certain printing parameters and communicates information to the user. For example, the memory may store the model number of the imaging cartridge so that the printer may recognize the imaging cartridge as one which is compatible with that particular imaging device. Additionally, by way of example, the cartridge memory may store the number of pages that can be expected to be printed from the imaging cartridge during a life cycle of the imaging cartridge and other useful data. The imaging device may also write certain data to the memory device, such as an indication of the amount of toner remaining in the cartridge. Other data stored in the memory device may relate to the usage history of the toner cartridge.

Typically, each type of imaging cartridge requires a different type of cartridge chip. While necessary to the proper operation of the imaging device, the differences between certain types of chip cartridges may be subtle or slight. With the ever increasing number of types and models of imaging devices and imaging cartridges being sold, remanufacturers must stock an increasing number of types of cartridge chips, with each type of cartridge chip usable with only a single type of imaging cartridge. It would be advantageous to provide systems and methods for a universal cartridge chip which operates with more than one type or model of imaging cartridge, and thus in more than one type or model of printer. Additionally, it would be advantageous to provide systems and methods for a universal cartridge chip which allows one type of imaging cartridge to be used in multiple types of imaging devices. Furthermore, it would be advantageous to provide systems and methods for a universal cartridge chip that allows remanufacturers of imaging cartridges to reduce the number of types of cartridge chips stored in their inventory.

### SUMMARY

In one aspect a method of operating a cartridge chip installed in an imaging device includes: transmitting a first value to the imaging device in response to a first request from the imaging device; if the first value is accepted by the imaging device, (a) receiving a command from the imaging device and (b) operating in a first mode of operation compatible with a first type of imaging device; if the value is not accepted by the imaging device, waiting for the imaging device to transmit a second request; transmitting a second value to the imaging device in response to a second request from the imaging device, the second value not equaling the first value; if the second value is accepted by the imaging device, (a) receiving a command from the imaging device and (b) operating in a second mode of operation compatible with a second type of imaging device.

In another aspect the command is an authentication command.

In another aspect the method includes, after receiving the authentication command, receiving a write command.

In another aspect, the method includes, after receiving the authentication command, determining the type of the imaging device.

In another aspect, the method wherein operating in the first mode of operation includes returning a first data value to the imaging device in response to a read request; and operating in a second mode of operation includes returning a second data value to the imaging device in response to a read request, said first data value differing from the second data value.

In another aspect, wherein the first value comprises at least a first key seed value including a first index value and the second value comprises at least a second key seed value including a second index value a second index value, the first key seed value differing from the second key seed value.

These and other features and objects of the invention will be more fully understood from the following detailed description of the embodiments, which should be read in light of the accompanying drawings.

In this regard, before explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for designing other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The accompanying drawings, which are incorporated in and form a part of the specification, illustrate embodiments of the present invention and, together with the description, serve to explain the principles of the invention.

FIG. 1 shows a functional block diagram of a universal chip;

FIG. 2 shows a perspective view of a universal chip; and

FIG. 3 shows a perspective view of a universal chip installed on an imaging cartridge.

### DETAILED DESCRIPTION OF THE DRAWINGS

The following detailed description of preferred embodiments refers to the accompanying drawings which illustrate specific embodiments of the invention. In the discussion that follows, specific systems and techniques for repairing, manufacturing or remanufacturing a toner cartridge comprising a cartridge chip including a memory element are disclosed. Other embodiments having different structures and operations for the repair, remanufacture and operation of other types of replaceable imaging components and for various types of imaging devices, such as laser printers, inkjet printers, copiers, facsimile machines and the like, do not depart from the scope of the present invention.

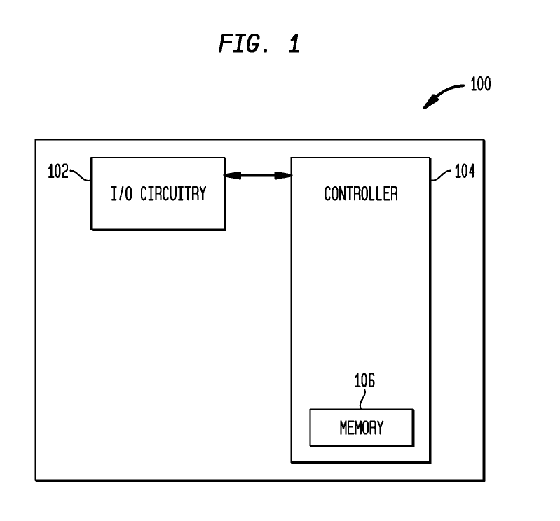

FIG. 1 shows a functional block diagram of a universal chip 100 in accordance with the present invention. The universal chip 100 may suitably include input and output (I/O) interface circuitry 102, a controller 104, and a memory 106. The I/O interface circuitry 102 is communicatively connected to the controller 104 and provides the appropriate electronic circuitry for the controller 104 to communicate with an imaging device, such as a printer. As an example, for imaging devices which communicate utilizing radio frequency (RF), the I/O interface circuitry 102 may include a radio frequency (RF) antenna and circuitry, and for a direct wired connection to imaging devices the I/O interface circuitry 102 may include one or more contact pads, or the like, and interface circuitry.

As described in greater detail below, the controller 104 controls the operation of the universal chip 100 and provides a functional interface to the memory 106, including controlling the reading of data from and the writing of data to the memory 106 by the printer. The data read from or written to the universal cartridge chip 100 may include a printer type, cartridge serial number, the number of revolutions performed by the organic photo conductor (OPC) drum (drum count), the manufacturing date, number of pages printed (page count), percentage of toner remaining, yield (expected number of pages), color indicator, toner-out indicator, toner low indicator, virgin cartridge indicator (whether or not the cartridge has been remanufactured before), job count (number of pages printed and page type), and any other data or program instructions that may be stored on the memory 106.

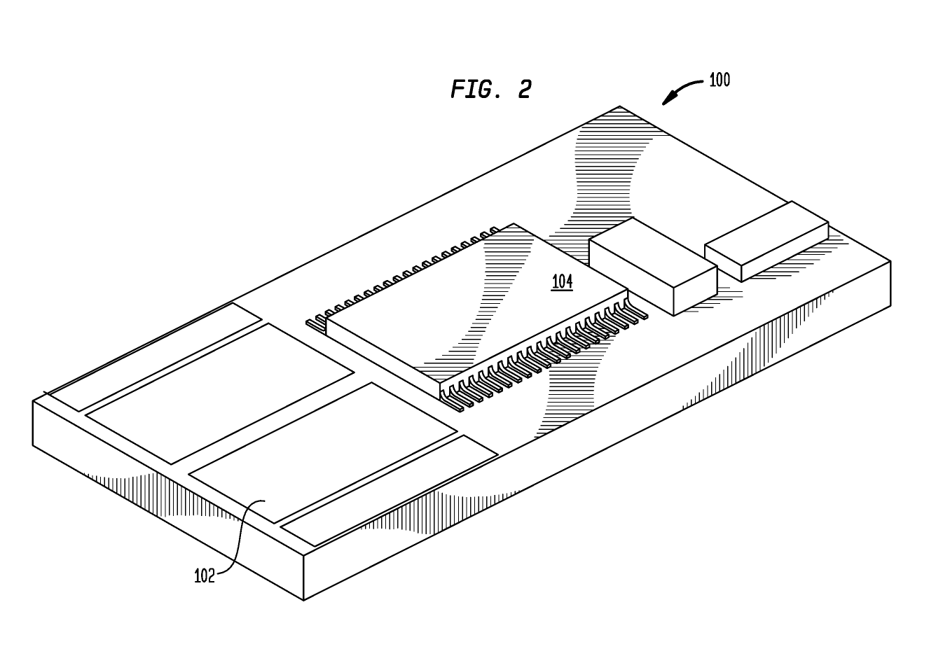

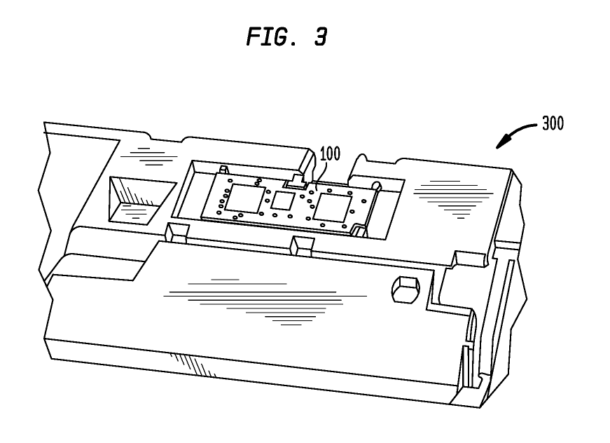

The controller 104 may be suitably implemented as a custom or semi-custom integrated circuit, a programmable gate array, a microprocessor executing instructions from the memory 106 or other memory, a microcontroller, or the like. Additionally, the controller 104, the memory 106 and/or the I/O interface circuitry 102 may be separated or combined in one or more physical modules. These modules may be suitably mounted to a printed circuit board to form the universal cartridge chip 100. FIG. 2 shows a perspective view of one embodiment of the universal cartridge chip 100 in accordance with the present invention. FIG. 3 shows a perspective view of another embodiment of the universal cartridge chip 100 installed on an exemplary imaging cartridge 300 in accordance with the present invention.

Different printer types may communicate or interface with in different ways with the cartridge chips installed on toner cartridges. Different printer types may include printers that differ by model number, firmware version, region of operation and other differences. These different printer types may expect differing data to be stored in the cartridge chip or utilize the stored data in different ways

Based at least partially on the communication signals received from the imaging device, the universal chip determines if the imaging device is a first type of imaging device or a second type of imaging device. If the universal chip 100 determines that the imaging device is the first type of imaging device, the universal chip 100 operates in a first mode of operation compatible with the first type of imaging device. If the universal chip 100 determines that the imaging device is the second type of imaging device, the universal cartridge chip operates in a second mode of operation compatible with the second type of imaging device.

In one aspect of the present invention, different types of imaging devices communicate with cartridge chips by issuing a request instructing the cartridge chip to transmit data, such as a key seed value, to the imaging device. A key seed value may comprise an index and a serial number. A keys seed value may include a date code. The imaging device may use the index to check a look-up table which determines which key seed values the imaging device will authenticate with. The imaging device uses the index and the serial number together with data from the look-up table to generate an authentication key. Different types of imaging devices expect different key seed values to be returned by the installed cartridges. If the key seed value returned to the imaging device is the value expected by the imaging device, the imaging device will issue a command, such as an authenticate command followed by a write command, for example, which will allow authentication to proceed. The authenticate command indicates to the universal cartridge chip 100 that the key seed value transmitted to the imaging device was acceptable. If the key seed value returned to the imaging device is not the value expected by the imaging device, the imaging device may send another request for a key seed value to the cartridge chip. The imaging device may continue sending key seed requests multiple times until the cartridge chip sends the expected key seed value.

A universal cartridge chip 100 in accordance with the present invention may store in the memory 106 multiple key seed values and a different dataset associated with each key seed value. Each key seed value and its associated dataset is selected for use with a particular printer type or types. Each dataset may comprise different data which is returned to different types of imaging devices when the imaging devices issue read commands to the universal cartridge chip 100. When the universal cartridge chip 100 is initially installed in an imaging device, the universal cartridge chip 100 may respond to the key seed request by sending a first key seed value to the imaging device.

If the imaging device responds to the first seed value by sending an authentication command, the universal cartridge chip 100 now knows that the first key seed value was the correct key seed value expected by the imaging device. The universal cartridge chip 100 now knows the type of imaging device. The universal cartridge chip 100 then proceeds to use a dataset associated with the first key seed when responding to subsequent read requests from the imaging device and in further communication with the imaging device, thus operating in a first mode of operation.

If the imaging device responds to the first seed value by not sending an authentication command, the universal cartridge chip 100 knows that the first key seed value was not the correct value expected by the imaging device. When the imaging device then sends a second key seed request, the universal cartridge chip 100 may respond by sending a second key seed value to the imaging device. The second key seed value is not equal to the first key seed value.

If the imaging device responds to the second seed value by sending an authentication command, the universal cartridge chip 100 now knows that the second key seed value was the correct key seed value expected by the imaging device. The universal cartridge chip 100 now knows the type of imaging device. The universal cartridge chip 100 then proceeds to use the dataset associated with the second key seed when responding to subsequent read requests from the imaging device and in further communication with the imaging device, thus operating in a second mode of operation different from the first mode of operation.

If the imaging device responds to the second seed value by not sending an authentication command, the universal cartridge chip 100 knows that the second key seed value was not the correct value expected by the imaging device. When the imaging device then sends a third key seed request, the universal cartridge chip 100 may respond by sending a third key seed value to the imaging device. The third key seed value is not equal to the first key seed value or the second key seed value.

The above process may be repeated until the universal cartridge chip 100 has determined the type of imaging device and thus know which dataset to use in communications with the imaging device.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A method of operating a cartridge chip installed in an imaging device comprising:
transmitting a first value to the imaging device in response to a first request from the imaging device;
if the first value is accepted by the imaging device, (a) receiving a command from the imaging device and (b) operating in a first mode of operation compatible with a first type of imaging device;
if the value is not accepted by the imaging device, waiting for the imaging device to transmit a second request;
transmitting a second value to the imaging device in response to a second request from the imaging device, the second value not equaling the first value;
if the second value is accepted by the imaging device, (a) receiving a command from the imaging device and (b) operating in a second mode of operation compatible with a second type of imaging device.

2. The method of claim 1 wherein the command is an authentication command.

3. The method of claim 2 wherein after receiving the authentication command:
receiving a write command.

4. The method of claim 2 further comprising:
after receiving the authentication command, determining the type of the imaging device.

5. The method of claim 4 wherein:
operating in the first mode of operation includes returning a first data value to the imaging device in response to a read request; and
operating in a second mode of operation includes returning a second data value to the imaging device in response to a read request, said first data value differing from the second data value.

6. The method of claim 5 wherein the first value comprises at least a first key seed value including a first index value and the second value comprises at least a second key seed value including a second index value a second index value, the first key seed value differing from the second key seed value.

7. A cartridge chip for operating in an imaging device, the cartridge chip comprising a controller and memory adapted for:
transmitting a first value to the imaging device in response to a first request from the imaging device;
if the first value is accepted by the imaging device, (a) receiving a command from the imaging device and (b) operating in a first mode of operation compatible with a first type of imaging device;
if the value is not accepted by the imaging device, waiting for the imaging device to transmit a second request;
transmitting a second value to the imaging device in response to a second request from the imaging device, the second value not equaling the first value;
if the second value is accepted by the imaging device, (a) receiving a command from the imaging device and (b) operating in a second mode of operation compatible with a second type of imaging device.

8. The cartridge chip of claim 7 wherein the command is an authentication command.

9. The cartridge chip of claim 8 wherein after receiving the authentication command the cartridge chip is adapted for:
receiving a write command.

10. The cartridge chip of claim 8 wherein the cartridge chip is adapted for:
after receiving the authentication command, determining the type of the imaging device.

11. The cartridge chip of claim 10 wherein the cartridge chip is adapted for:
operating in the first mode of operation includes returning a first data value to the imaging device in response to a read request; and
operating in a second mode of operation includes returning a second data value to the imaging device in response to a read request, said first data value differing from the second data value.

12. The cartridge chip of claim 11 wherein the first value comprises at least a first key seed value including a first index value and the second value comprises at least a second key seed value including a second index value a second index value, the first key seed value differing from the second key seed value.
